(19) United States
(12) Patent Application Publication
(10) Pub. No.: US 2004/0071080 A1
(43) Pub. Date: Apr. 15, 2004

(54) Label switching router and path switchover control method thereof

(75) Inventors: Motohiro Uchiyama, Kawasaki (JP); Yasuhiro Kajiwara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/669,372

(22) Filed: Sep. 25, 2003

(30) Foreign Application Priority Data
Sep. 30, 2002 (JP) 2002-287655

(51) Int. Cl. G06F 11/00

(52) U.S. Cl. 370/225; 370/242

(57) ABSTRACT

In a label switching router and a path switchover method thereof when a path fault occurs, a relay label switching router registers a hop destination indicated in a received message in a path hop list, forwards the message to a next hop destination without deleting the hop destination, and notifies an identifier of a path in which a fault has recovered to an ingress label switching router based on the path hop list, an egress label switching router registers the hop destination indicated in the received message in a path hop list, and notifies an identifier of a path in which a fault has recovered to the ingress label switching router based on the path hop list, and the ingress label switching router regards, when detecting a recovery of a path higher in priority than an active path or when receiving a recovery notification, the recovered path as an active path.

### BACKGROUND OF THE INVENTION

1. Field of the Invention

The present invention relates to a label switching router (hereinafter, occasionally abbreviated as LSR or simply referred to as router) and a path switchover method thereof, and in particular to a label switching router and a path switchover method thereof when a path fault occurs.

In recent years, broadband communication has been rapidly developed so that multimedia traffic transmitted has been more and more increasing. As a new switching/routing technology accommodating to this enormous multimedia traffic, an MPLS (MultiProtocol Label Switching), for example, has become remarkable. In this switching/routing technology, it is important to switch over a path while maintaining communication quality, even when a fault occurs in an active or working path.

2. Description of the Related Art

FIG. 10 shows an arrangement of a general MPLS network 100z, which is composed of an ingress LSR (hereinafter, occasionally referred to as ingress router) 10z_1 receiving a packet from a terminal 40_{—}x (or a node of a non-MPLS network 200_1), an egress LSR (hereinafter, occasionally referred to as egress router) 10z_3 transmitting a packet to a terminal 40_{—}y (or a node of a non-MPLS network 200_2), and relay LSR's (hereinafter, occasionally referred to as relay routers) 10z_2, 10z_4, 10z_5 and 10z_6.

The routers 10z_1-10z_6 may comprise a router, a switch, an ATM switch, a frame relay switch, or the like, which can accommodate to an MPLS.

The routers 10z_1-10z_3 are sequentially connected with links 50_1 and 50_2. The routers 10z_1, 10z_4, 10z_5, 10z_6, and 10z_3l are sequentially connected with links 50_3, 50_6, 50_7, and 50_5. The routers 10z_2 and 10z_5 are connected with a link 50_4.

When a packet is transmitted from the terminal 40_{—}x to the terminal 40_{—}y through the MPLS network 100z, an appropriate label switched path (hereinafter, occasionally abbreviated as LSP) satisfying constraint conditions, such as for designating a necessary bandwidth, an allowable range of delay and fluctuation, and the like, is established by “constraint-based-routing” in the MPLS network 100z. Hereinafter, this established LSP is occasionally referred to as CRLSP.

An example of a CRLSP established in the network composed of ATM switches accommodating to the MPLS is found in Patent Document 1 below.

FIG. 10 shows a CRLSP 70_1 (thick solid line) and a CRLSP 70_2 (thick dashed line) established by the constraint-based-routing between the ingress router 10z_1 and the egress router 10z_3.

FIGS. 11A and 11B show a flow list 62 and a CRLSP hop list 63 held by the ingress router 10z_1 when the CRLSP's 70_1 and 70_2 are established. FIG. 11A shows the flow list 62, which shows a destination IP address of a packet=“IPy”, a subnetwork mask thereof=“255.255.255.0”, a source IP address=“IPx”, a subnetwork mask thereof=“255.255.255.0”, a protocol=TCP, a destination port No.=“23”, a source port No.=“23”, a first-priority label switched path=“CRLSP 70_1”, and a second-priority label switched path=“CRLSP 70_2”.

Thus, making a route redundant by the first-priority CRLSP 70_1 and the second-priority CRLSP 70_2 realizes a detour function for a fault occurrence.

FIG. 11B shows the CRLSP hop list 63, which is composed of hop lists respectively associated with the CRLSP's 70_1 and 70_2. The hop list for the CRLSP 70_1 shows the IP addresses=“IP21” and “IP32” (see FIG. 10) of the input side interface of the relay router 10z_2 and the egress router 10z_3 through which the CRLSP 70_1 passes, and the subnetwork mask=“255.255.255.0” associated with the IP addresses.

Similarly, the hop list for the CRLSP 70_2 shows the IP addresses=“IP41”, “IP54”, “IP65”, and “IP36” (see FIG. 10) of the input side interface of the relay routers 10z_4-10z_6 and the egress router 10z_3 through which the CRLSP 70_2 passes, and the subnetwork mask=“255.255.255.0” associated with the IP addresses.

FIG. 12 shows an establishment procedure of the CRLSP 70_1. Label request messages 700z_1 and 700z_2 (hereinafter, occasionally represented by reference numerals 700z and 700) are transmitted to the egress router 10z_3 through the relay router 10z_2. A label mapping message 800_2 responding to the label request messages is transmitted to the relay router 10z_2 from the egress router 10z_3, and then, a label mapping message 800_1 is transmitted to the ingress router 10z_1 from the relay router 10z_2.

FIG. 13 shows the label request messages 700 and 700z. This label request message 700 is composed of a header field 710 and a TLV (Type-Length-Value) parameter field 720. The header field 710 is composed of a message type 711 including a U bit 711_1, a message length 712, and a message ID 713.

In the message type 711, “0×0401” indicating a label request message is set. In the U bit, a method of handling a message when a message type can not be recognized is designated. In the message length, a length of the message ID 713 and the TLV parameter field 720 following the message length field 712 is designated on a byte-by-byte basis. In the message ID 713, the ID of the message 700 is set.

The TLV parameter field 720 is composed of a forwarding equivalence class TLV 721, a return message ID TLV 722, a label switched path ID TLV 723, an explicit route TLV 724, a traffic TLV 725, a route pinning TLV 726, a resource class TLV 727, and a pre-emption TLV 728.

Among these, the explicit route TLV 724 is a field for designating a route of a CRLSP. In this field, is set e.g. the destination IP address or the like set in the list for the CRLSP 70_1 in the hop list 63 shown in FIG. 11B.

FIG. 14 shows the explicit route TLV 724 shown in FIG. 13, which is composed of first two bits 731 and 732 whose values are respectively “0”, a TLV type field 733 in which “0×0800” indicating an explicit route TLV is set, a length field 734, and explicit route hop TLV's 740_1-740_{—}n (hereinafter, occasionally represented by a reference numeral 740).

FIG. 15A shows a general format of the explicit route hop TLV 740, which is composed of a bit 741=“0”, a bit 742=“0”, an ER hop type 743=“0×0800”, a length field 744, and a content 750.

FIG. 15B shows the explicit route hop TLV 740 when an explicit route is designated by an IPv4 address. An L bit 745, a reserved field 746, a prefix length 747, and an IPv4 address 748 correspond to the content 750 in FIG. 15A.

The ER hop type 743=“0×0801” indicates that a type is “IPv4, prefix”. In the length field 744, “8 bytes” is set.

When the L bit 745=“0”, it indicates that the next hop destination is a strict hop. When the L bit 745=“1”, it indicates that the next hop destination is a loose hop.

In the prefix length (PreLen) 747 and the IPv4 address 748, a prefix length 1-32 of the next hop destination and a 4-byte IPv4 address are respectively set.

Hereinafter, a procedure of establishing the CRLSP 70_1 will be described in more detail based on the CRLSP establishment procedure shown in FIG. 12.

Step S51: The ingress router 10z_1 prepares the label request message 700z_1, and sets, based on the CRLSP hop list 63 (see FIG. 11B), the destination IP address=“IP21” of the first hop destination router 10z_2 of the CRLSP 70_1, the prefix length=“24” of the subnetwork mask=“255.255.255.0”, and the L bit=“0” in the explicit route hop TLV 740_1 of the message 700z_1.

The ingress router 10z_1 further sets the destination IP address

=“IP21” of the next (last) hop destination router 10z_3 of the CRLSP 70_1, the prefix length=“24” of the subnetwork mask=“255.255.255.0”, and the L bit=“0” in the explicit route hop TLV 740_2.

The ingress router 10z_1 transmits the label request message 700z_1 to the relay router 10z_2.

Step S52: Since the IP address=“IP21” of the interface having received the label request message 700z_1 is the same as the IP address=“IP21” of the explicit route hop TLV 740_1 of the message 700z_1, the relay router 10z_2 determines that the label request message 700z_1 is addressed to itself.

The relay router 10z_2 deletes the explicit route hop TLV 740_1 designating its own router from the label request message 700z_1, and transmits the label request message 700z_2, to the egress router 10z_3, in which the explicit route hop TLV 740_2 is made the explicit route hop TLV 740_1.

Step S53: Since the explicit route hop TLV 740_1 of the label request message 700z_2 received indicates the IP address=“IP32” of the interface which has received the message 700z_2, the egress router 10z_3 determines that the label request message 700z_2 is addressed to its own router, and recognizes that its own router is the last message receiver since the explicit route hop TLV 740_1 is the last explicit route hop TLV.

Step S54: The egress router 10z_3 maps a label L1 to the CRLSP 70_1, and transmits a label mapping message 800_2 including the label L1 to the relay router 10z_2.

Step S55: The relay router 10z_2 receives the label L1 included in the label mapping message 800_2, maps a label L2 to the CRLSP 70_1, and stores a list indicating a correspondence between the label L1 and the label L2.

The relay router 10z_2 further transmits the label mapping message 800_1 including the label L2 to the ingress router 10z_1.

Step S56: The ingress router 10z_1 makes the label L2 included in the label mapping message 800_1 received correspond to the CRLSP 70_1 to be stored in e.g. the flow list 62 (see FIG. 11A, where correspondence between the label L2 and the CRLSP 70_1 is not shown).

Thus, the first-priority CRLSP 70_1 is established (set up). Similarly, it is possible to establish the second-priority CRLSP 70_2, and furthermore the third-priority CRLSP 70_3 (not shown) passing through e.g. the ingress router 10z_1, the relay routers 10z_4, 10z_5, and 10z_2, and the egress 10z_3.

Patent Document 1:

Japanese Patent Application Laid-open No.2001-197116 (page 4, FIGS. 1-4)

FIG. 16 shows a path switchover at a path fault occurrence. In the detour function by the redundant route of the prior art CRLSP, when a fault occurs in e.g. the link 50_2 (see step S61), i.e. the first-priority CRLSP 70_1, the first-priority CRLSP 70_1 is released and is changed over to the second-priority CRLSP 70_2 (see step S62).

When a fault occurs in the second-priority CRLSP 70_2, the CRLSP is switched over to the third-priority CRLSP 70_3. Furthermore, when a fault occurs in the third-priority CRLSP 70_3, communication is switched over to best effort communication. However, even if the link 50_2, for example, recovers from the fault and the first-priority CRLSP 70_1 is returned to an available state, there is no protocol for switching back to the CRLSP 70_1. Accordingly, most of the FEC communication finally leads to the best effort communication without guarantee of QoS.

In the best effort communication, there is no merit of CRLSP by the MPLS such as explicitly routed label switched path and QoS (Quality of Service) guarantee. In order to recover the original state, switching back of the CRLSP is necessary. Also, while the second or the third-priority CRLSP is used, the CRLSP is required to be stopped/re-registered, and the communication by the CRLSP between the terminals 40_{—}x and 40_{—}y has to be once stopped. This leads to occurrence of many problems such as load increase of a network management person and a stop of communication services.

Furthermore, in the establishment procedure of the CRLSP 70_1 shown in FIG. 12, only the ingress router 10z_1 holds the hop destination of the CRLSP 70_1, and the relay router 10z_2 and the egress router 10z_3 can not grasp which hop to be passed through. Accordingly, after a fault occurs in the CRLSP 70_1 and it is released, the relay router 10z_2 and the egress router 10z_3 can not grasp the CRLSP 70_1 which should exist.

For this reason, it is difficult to instantaneously notify a fault recovery to the ingress router 10z_1 when the link 50_2 is recovered from a fault.

### SUMMARY OF THE INVENTION

It is accordingly an object of the present invention to provide a label switching router and a path switchover method thereof when a path fault occurs, wherein an active path is switched back to a path higher in priority when the path higher in priority is recovered.

In order to achieve the above-mentioned object, an ingress label switching router according to the present invention comprises: a path table for designating an active path from among a plurality of paths through which packets of an equivalence class are forwarded and for which priorities are set; and a fault detector for operating the active path by referring to the path table and for setting, when detecting a recovery of a path higher in priority than the active path, the recovered path in the path table as an active path (claim 1).

Namely, an ingress label switching router forwards a packet of e.g. a forwarding equivalence class (hereinafter, abbreviated as FEC) by using an active path designated by a path table from among a plurality of paths for which priorities are set, based on the table.

A fault detector detects a path fault and a recovery from the fault. When detecting a recovery of a path higher in priority than the active path set in the path table, the fault detector sets the recovered path in the path table as an active path.

It is to be noted that as for a method of detecting an occurrence of a path fault and a recovery from the fault, the fault detector may directly detect them or receive a notification from e.g. another router or the like.

Thus, the active path lower in priority can be switched back to the recovered path higher in priority by the fault detector based on the latest path table.

Also, in the present invention, when detecting a path recovery from a fault, the fault detector may immediately set the recovered path in the path table as an active path (claim 2).

Also, in the present invention, when detecting a path recovery from a fault, the fault detector may confirm the path recovery by testing the recovered path, and then may set the recovered path in the path table as an active path (claim 3).

Also, in the present invention, when a fault occurs in the active path after a path recovery from a fault is detected, the fault detector may set the recovered path in the path table as an active path (claim 4).

In order to achieve the above-mentioned object, a relay label switching router according to the present invention comprises: a path hop list for indicating a hop destination of a path through which a packet of an equivalence class is forwarded; a message processor for registering the hop destination indicated in a received message in the path hop list and for forwarding the message to a next hop destination without deleting the hop destination; and a fault detector for notifying an identifier of a path in which a fault has recovered to an ingress label switching router based on the path hop list (claim 5).

Namely, a hop destination (e.g. IP address, autonomous system No., local CRLSP) of a path through which a packet of an equivalence class is forwarded can be registered in a path hop list.

A message processor registers the hop destination explicitly indicated in a received message in the path hop list. Furthermore, the message processor forwards the received message to a next hop destination without deleting the hop destination indicated in the message.

A fault detector notifies an ID of a path in which a fault has recovered to an ingress label switching router. It is to be noted that this notification may be made by a message through the message processor.

Thus, it becomes possible for a relay label switching router to recognize a hop destination of a path through which a packet of an equivalence class is forwarded, i.e. links to be passed through. Also, it becomes possible for a relay label switching router to notify the hop destinations having passed therethrough to a downstream relay label switching router and an egress label switching router.

Also, an active path can be switched back to a path higher in priority than the active path by an ingress label switching router to which an ID of a path in which a fault has recovered is notified.

Also, in the present invention, the fault detector may notify an identifier, detected by the fault detector itself or notified by a downstream label switching router, of a path in which a fault has recovered to an upstream label switching router based on the path hop list (claim 6).

Namely, the fault detector can notify an ID of a path in which a fault has recovered, detected by the fault detector itself to an upstream label switching router based on the path hop list. Also, the fault detector can notify the ID of the path in which the fault has recovered, notified by a downstream label switching router to the upstream label switching router based on the path hop list.

By repeating this notification, it becomes possible to finally notify the ID of the path in which the fault has recovered to the ingress label switching router.

It is to be noted that the upstream label switching router notified by the fault detector is not limited to a facing upstream label switching router, but may be a further upstream label switching router.

Also, in the present invention, the message may include an address of an ingress label switching router as a hop destination, the message processor may register the address associated with the path in the path hop list, and the fault detector may directly notify a path recovery from a fault to the ingress label switching router (claim 7).

Namely, the message includes an address of an ingress label switching router. The message processor registers the address associated with the path in the path hop list.

The fault detector directly notifies a path recovery from a fault to the ingress label switching router.

Thus, it becomes possible for the ingress label switching router to recognize the ID of the path in which the fault has recovered.

In order to achieve the above-mentioned object, an egress label switching router according to the present invention comprises: a path hop list for indicating a hop destination of a path through which a packet of an equivalence class is forwarded; a message processor for registering the hop destination indicated in a received message in the path hop list; and a fault detector for notifying an identifier of a path in which a fault has recovered to an ingress label switching router based on the path hop list (claim 9).

Namely, a message processor registers a hop destination, indicated in a received message, of a path through which a packet of an equivalence class is forwarded in the path hop list.

A fault detector detects a path recovery from a fault, and notifies an ID of the path in which the fault has recovered to an ingress label switching router based on the path hop list.

Thus, it becomes possible for the relay label switching router to recognize the hop destination of the path through which a packet of an equivalence class is forwarded, i.e. the links to be passed through. Also, the active path can be switched back to a path higher in priority than the active path by the ingress label switching router having received the ID of the recovered path.

Also, in the present invention, the fault detector may notify an identifier, detected by the fault detector itself, of a path in which a fault has recovered to an upstream label switching router based on the path hop list (claim 10).

Namely, the fault detector can notify an ID, detected by the fault detector itself, of a path in which a fault has recovered to an upstream label switching router based on the path hop list.

By repeating this notification, it becomes possible to finally notify the ID of the path in which the fault has recovered to the ingress label switching router.

It is to be noted that the upstream label switching router notified by the fault detector is not limited to a facing upstream label switching router.

Also, in the present invention the message may include an address of an ingress label switching router as a hop destination, the message processor may register the address associated with the path in the path hop list, and the fault detector may directly notify a path recovery from a fault to the ingress label switching router (claim 11).

Namely, the message includes an address of an ingress label switching router. The message processor registers the address of the ingress label switching router associated with the path in the path hop list.

The fault detector directly notifies a path recovery from a fault to the ingress label switching router.

Thus, it becomes possible for the ingress label switching router to recognize the ID of the path in which the fault has recovered.

Also, in the present invention, the message may comprise a label request message (claims 8 and 12).

In order to achieve the above-mentioned object, a path switchover control method of an ingress label switching router according to the present invention comprises: a first step of designating an active path from among a plurality of paths through which packets of an equivalence class are forwarded and for which priorities are set; and a second step of operating the active path by referring to the path table and for setting, when detecting a recovery of a path higher in priority than the active path, the recovered path in the path table as an active path (claim 13).

Namely, an ingress label switching router designates an active path from among a plurality of paths through which packets of an equivalence class are forwarded and for which priorities are set.

The ingress label switching router operates the active path by referring to the path table, and sets, when detecting a recovery of a path higher in priority than the active path, the recovered path as an active path.

Thus, the active path lower in priority can be switched back to a recovered path higher in priority, based on the latest path table, by the ingress label switching router.

Also, in the present invention, when a path recovery from a fault is detected, the second step may immediately set the recovered path in the path table as an active path (claim 14).

Also, in the present invention, when a path recovery from a fault is detected, the second step may confirm the path recovery by testing the recovered path, and then may set the recovered path in the path table as an active path (claim 15).

Also, in the present invention, when a fault occurs in the active path after a path recovery from a fault is detected, the second step may set the recovered path in the path table as an active path (claim 16).

In order to achieve the above-mentioned object, a path switchover control method of a relay label switching router according to the present invention comprises: a first step of registering in a path hop list a hop destination indicated in a received message of a path, through which a packet of an equivalence class is forwarded; a second step of forwarding the message to a next hop destination without deleting the hop destination; and a third step of notifying an identifier of a path in which a fault has recovered to an ingress label switching router based on the path hop list (claim 17).

Namely, a relay label switching router registers in a path hop list a hop destination indicated in a received message of a path, through which a packet of an equivalence class is forwarded. The relay label switching router forwards the message to a next hop destination without deleting the hop destination.

Furthermore, the relay label switching router notifies an ID of a path in which a fault has recovered to an ingress label switching router based on the path hop list.

Thus, the active path can be switched back to the path, in which the fault has recovered, higher in priority than the active path by the ingress label switching router.

Also, in the present invention, the third step may notify an identifier, detected by its own relay label switching router or notified by a downstream label switching router, of a path in which a fault has recovered to an upstream label switching router based on the path hop list (claim 18).

Namely, the relay label switching router can notify an ID, detected by its own relay label switching router, of a path in which a fault has recovered, to an upstream label switching router based on the path hop list. Also, the relay label switching router can notify an ID, notified by a downstream label switching router, of a path in which a fault has recovered, to an upstream label switching router based on the path hop list.

By repeating this notification, it becomes possible to finally notify the ID of the path in which the fault has recovered to the ingress label switching router.

Also, in the present invention, the message may include an address of an ingress label switching router as the hop destination, the first step may register the address associated with the path in the path hop list, and the third step may directly notify an identifier of a path in which a fault has recovered to the ingress label switching router (claim 19).

In order to achieve the above-mentioned object, a path switchover control method of an egress label switching router according to the present invention comprises: a first step of registering in a path hop list a hop destination indicated in a received message of a path, through which a packet of an equivalence class is forwarded; and a second step of notifying an identifier of a path in which a fault has recovered to an ingress label switching router based on the path hop list (claim 21).

Namely, the egress label switching router registers in a path hop list a hop destination indicated in a received message of a path, through which a packet of an equivalence class is forwarded. The egress label switching router notifies an ID of a path in which a fault has recovered to an ingress label switching router based on the path hop list.

Thus, the active path can be switched back to a path higher in priority than the active path by the ingress label switching router.

Also, in the present invention, the second step may notify an identifier, detected by its own egress label switching router, of a path in which a fault has recovered to an upstream label switching router based on the path hop list (claim 22).

Namely, the egress label switching router can notify an ID, detected by its own egress label switching router, of a path in which a fault has recovered to an upstream label switching router based on the path hop list.

By repeating this notification, it becomes possible to finally notify the ID of the path in which the fault has recovered to the ingress label switching router.

It is to be noted that the upstream label switching router notified by the fault detector is not limited to a facing upstream label switching router.

Also, in the present invention, the message may include an address of an ingress label switching router as a hop destination, the first step may register the address associated with the path in the path hop list, and the second step may directly notify a path recovery from a fault to the ingress label switching router (claim 23).

Also, in the present invention, the message may comprise a label request message (claims 20 and 24).

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an embodiment of an ingress label switching router, a relay label switching router, and an egress label switching router which are label switching routers according to the present invention;

FIGS. 2A-2C are diagrams showing examples of a list and the like held by an ingress label switching router which is a label switching router according to the present invention;

FIG. 3 is an operational sequence diagram showing an example of a CRLSP establishment procedure in a network composed of label switching routers according to the present invention;

FIG. 4 is a diagram showing an example of a CRLSP hop list held by a relay label switching router among label switching routers according to the present invention;

FIG. 5 is a diagram showing an example of a CRLSP hop list held by an egress label switching router among label switching routers according to the present invention;

FIG. 6 is a diagram showing an example of a CRLSP hop list held by a relay label switching router among label switching routers according to the present invention;

FIGS. 7A and 7B are diagrams showing an example of a path switchover operational procedure in a network composed of label switching routers according to the present invention;

FIGS. 8A and 8B are diagrams showing an example (1) of a path switching back operational procedure in a network composed of label switching routers according to the present invention;

FIGS. 9A-9C are diagrams showing an example (2) of a path switching back operational procedure in a network composed of label switching routers according to the present invention;

FIG. 10 is a block diagram showing an example of an MPLS network composed of general label switching routers;

FIGS. 11A and 11B are diagrams showing examples of lists held by an ingress label switching router which is a general label switching router;

FIG. 12 is an operational sequence diagram showing a prior art CRLSP establishment procedure;

FIG. 13 is a diagram showing a format of a general label request message;

FIG. 14 is a diagram showing a format of a general explicit route TLV;

FIGS. 15A and 15B are diagrams showing formats of a general explicit route hop TLV; and

FIG. 16 is a block diagram showing a path switchover in an MPLS network composed of prior art label switching routers.

### DESCRIPTION OF THE EMBODIMENTS

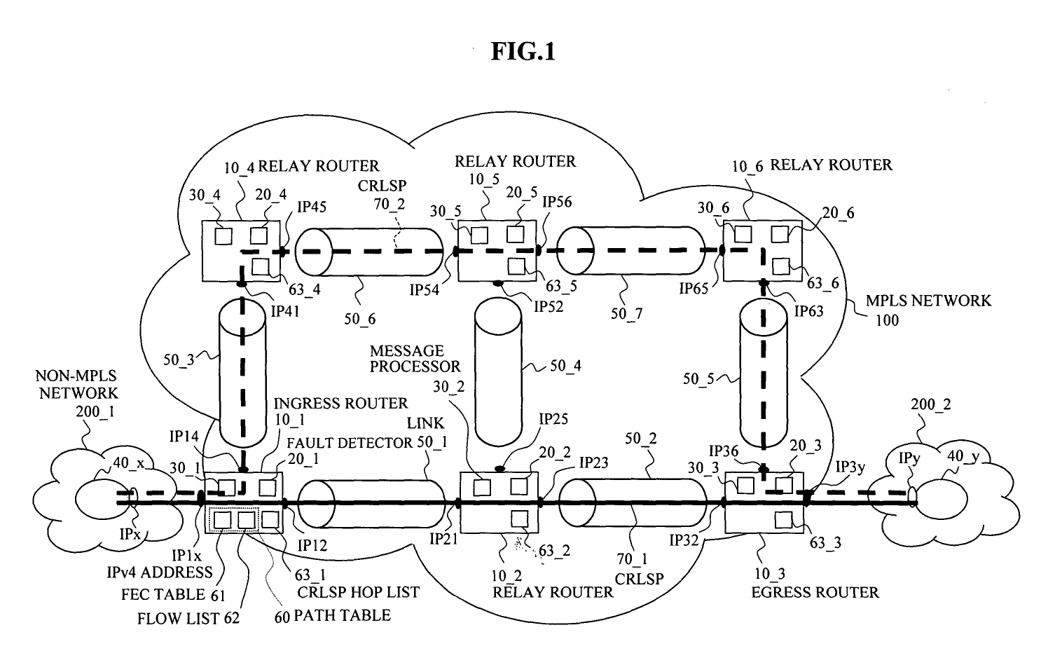

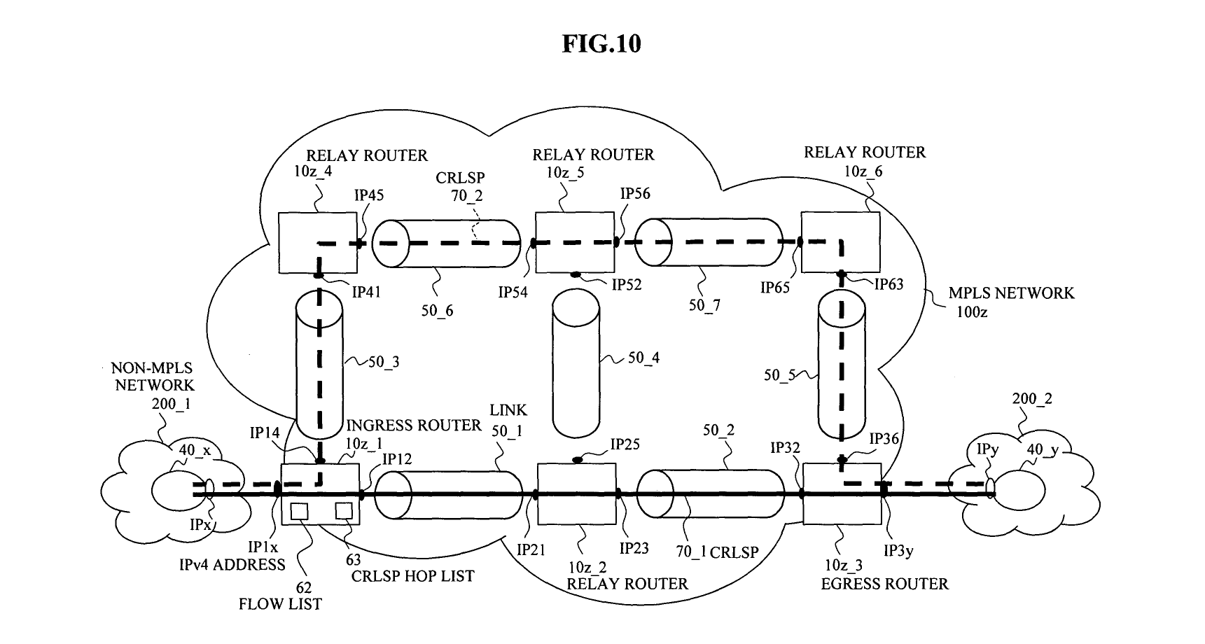

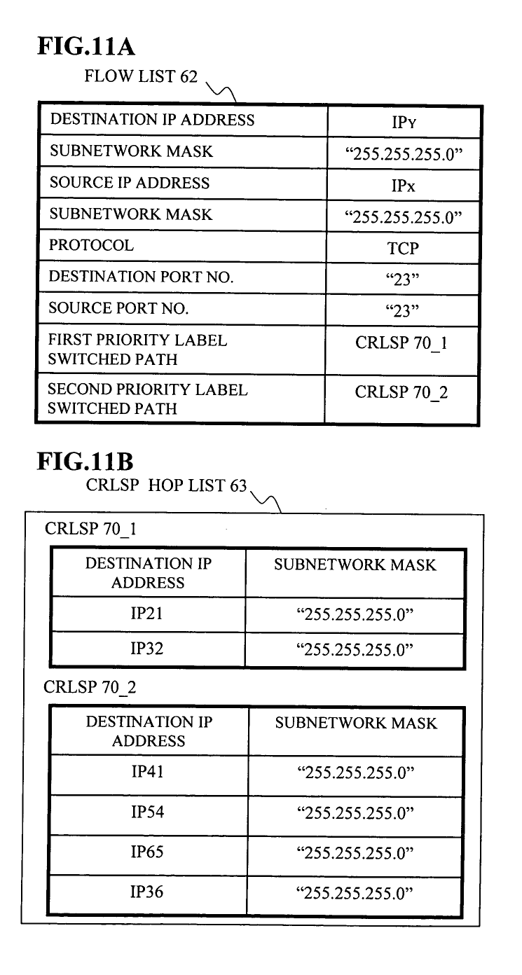

FIG. 1 shows an embodiment of a label switching router 10 according to the present invention. An arrangement of a MPLS network 100 shown in FIG. 1 is the same as that of the MPLS network 100z shown in FIG. 10.

An ingress router 10_1 is provided with a fault detector 20_1, a message processor 30_1, a path table 60 and a CRLSP hop list 63_1. This path table 60 is composed of an FEC table 61 and a flow list 62.

Routers 10_2-10_6 are respectively provided with fault detectors 20_2-20_6, message processors 30_2-30_6, and CRLSP hop lists 63_2-63_6.

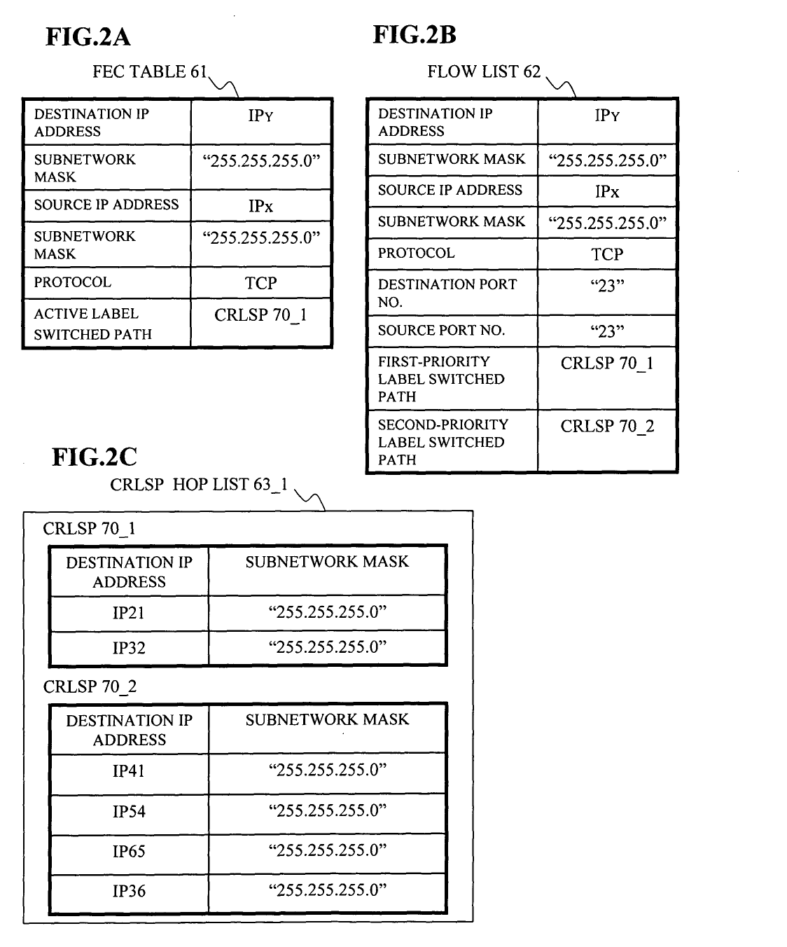

FIGS. 2A-2C respectively show arrangements of the FEC table 61, the flow list 62, and the CRLSP hop list 63_1 held by the ingress router 10_1.

The FEC table 61 shown in FIG. 2A is composed of a destination IP address=“IPy”, a subnetwork mask thereof=“255.255.255.0”, a source IP address=“IPx”, a subnetwork mask thereof=255.255.255.0”, a protocol=TCP, and an active label switched path=“CRLSP 70_1”.

The flow list 62 shown in FIG. 2B is composed of the destination IP address=“IPy”, the subnetwork mask thereof=“255.255.255.0”, the source IP address=“IPx”, the subnetwork mask thereof=255.255.255.0”, the protocol=TCP, a destination port No.=“23”, a source port No.=“23”, a first-priority label switched path=“CRLSP 70_1”, and a second-priority label switched path=“CRLSP 70_2”.

The path table 60 is composed of the FEC table 61 and the flow list 62 as mentioned above. By referring to the path table 60, it is recognized that the CRLSP 70_1 (FEC table) is active among the CRLSP's 70_1 and 70_2 (see flow list 62) for which priorities are provided.

The CRLSP hop list 63_1 shown in FIG. 2C is composed of the destination IP addresses respectively indicating the hop destinations of the CRLSP's 70_1 and 70_2 and their subnetwork masks.

As the hop destination of the CRLSP 70_1, the IP address=“IP21” (see FIG. 1) of the relay router 10_2 and the IP address=“IP32” of the egress router 10_3 are set in this order.

As the hop destination of the CRLSP 70_2, the IP addresses=“IP41”, “IP54”, “IP65”, and “IP36” (see FIG. 1) of the relay routers 10_4-10_6 and the egress router 10_3 are set in this order.

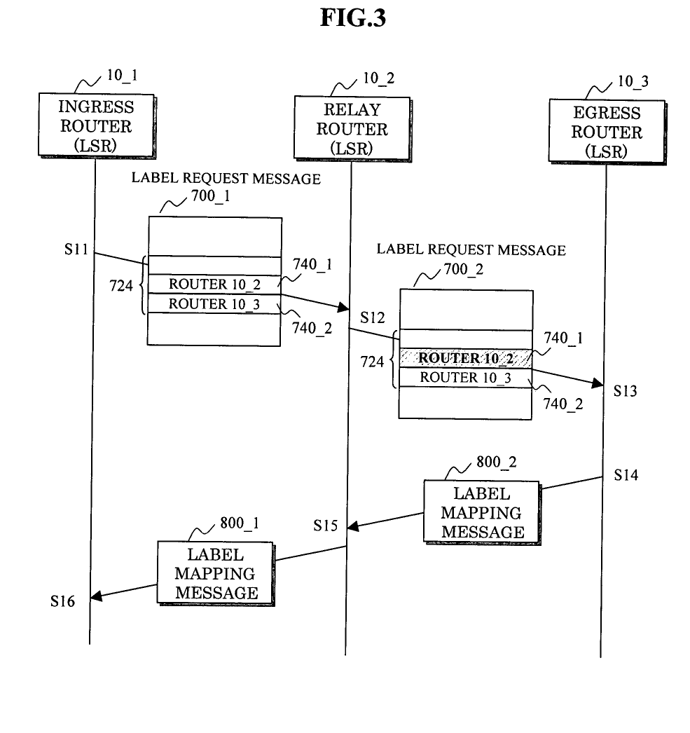

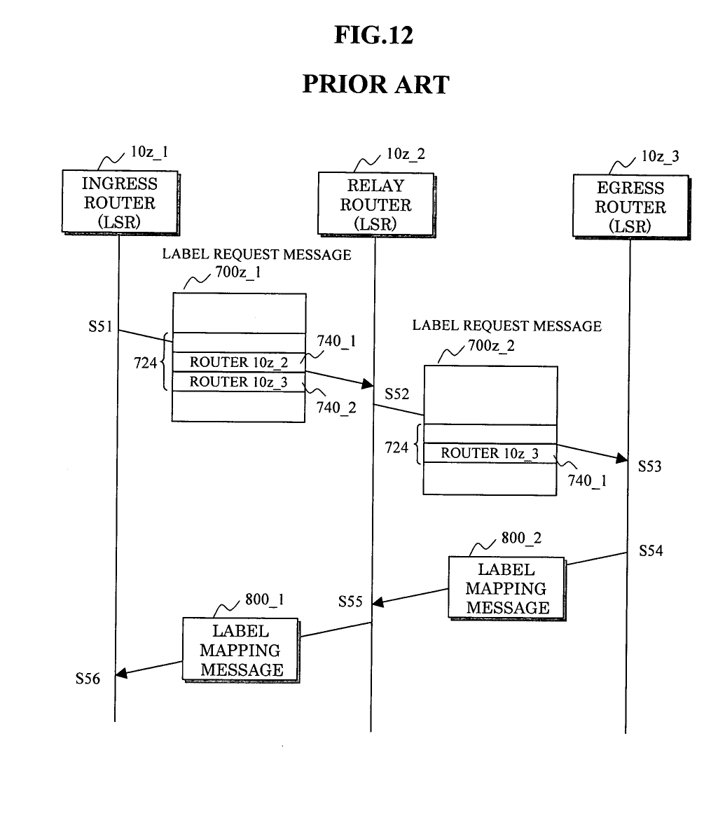

FIG. 3 shows a procedure of establishing the CRLSP 70_1 shown in the CRLSP hop list 63_1 of FIG. 2C. While this procedure is the same as that of the prior art shown in FIG. 12, it is different from the prior art procedure in that the relay router 10_2 having received a label request message 700 transfers this message 700 to a router of a next hop destination without deleting an explicit route hop TLV designating its own relay router 10_2 and included in the message 700.

Also, this procedure is different from the prior art procedure in that the relay router 10_2 and the egress router 10_3 having received the message 700 respectively store “explicit route hop destinations” included in the message 700 in CRLSP hop lists 63_2 and 63_3.

The establishment procedure of the CRLSP 70_1 will now be described by referring to FIGS. 2A-2C.

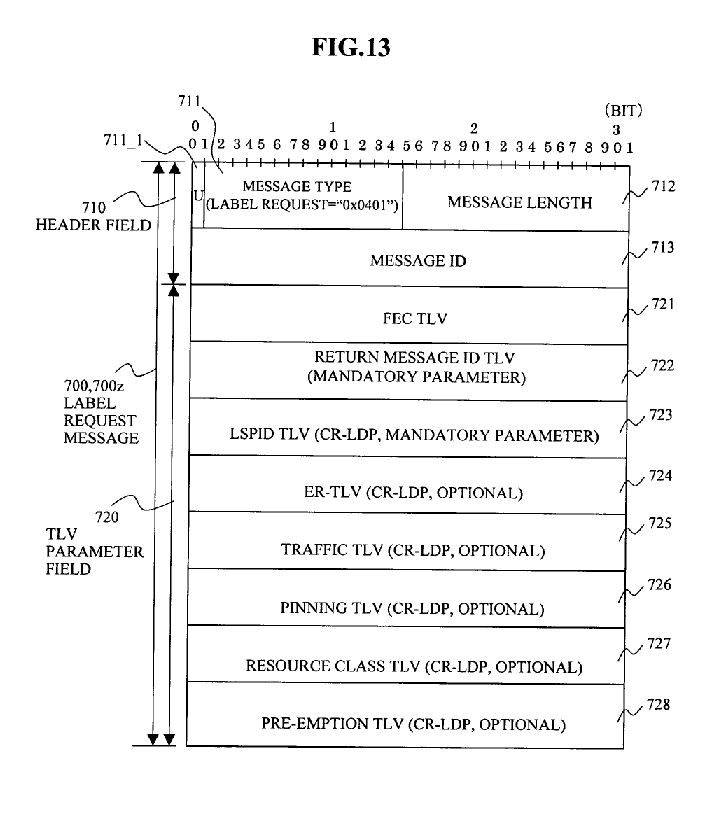

Step S11: In the ingress router 10_1, the message processor 30_1 prepares a label request message 700_1 (see FIGS. 13, 14, 15A, and 15B).

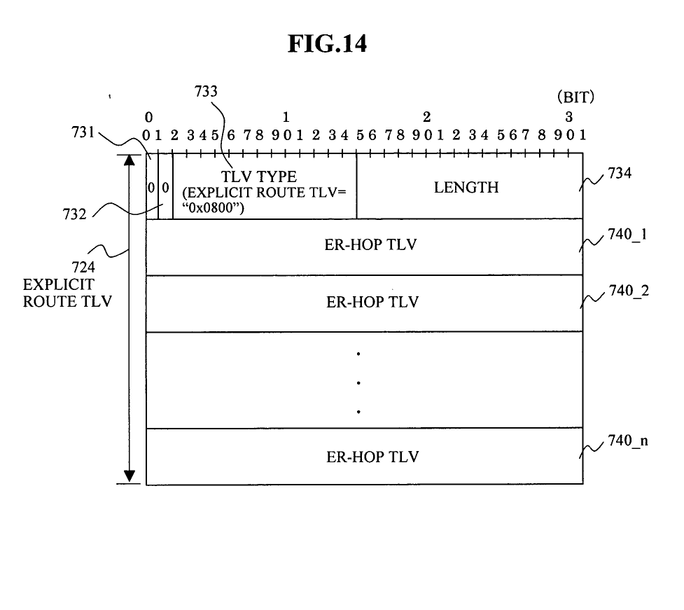

The message processor 30_1 sets the IP addresses=“IP21” and “IP32” of the hop destinations, the prefix lengths=“24” and “24” of the subnetwork masks “255.255.255.0” and “255.255.255.0” in explicit route hop TLV's 740_1 and 740_2 (see FIGS. 13, 14, 15B; in this example, n=“2” for 740_n in FIG. 14) of the label request message 700_1 respectively based on the preset list (see FIG. 2C) of the CRLSP 70_1 in the CRLSP hop list 63_1. It is to be noted that L bits of the explicit route hop TLV's 740_1 and 740_2 are set to strict=“0”.

Then, the message processor 30_1 transmits the label request message 700_1 to the relay router 10_2.

Step S12: In the relay router 10_2, the interface (not shown) whose IP address=“IP21” (see FIG. 1) receives the label request message 700_1.

Since the IP address=“IP21” indicated in the explicit route hop TLV 740_1 of the label request message 700_1 is the same as that of its own interface, the message processor 30_2 (see FIG. 1) recognizes the label request message 700_1 is addressed to itself.

The message processor 30_2 stores the explicit route hop TLV's 740_1 and 740_2 included in the label request message 700_1 in the list corresponding to the CRLSP 70_1 in the CRLSP hop list 63_2. Thus, the relay router 10_2 can recognize the hop destinations of the CRLSP 70_1.

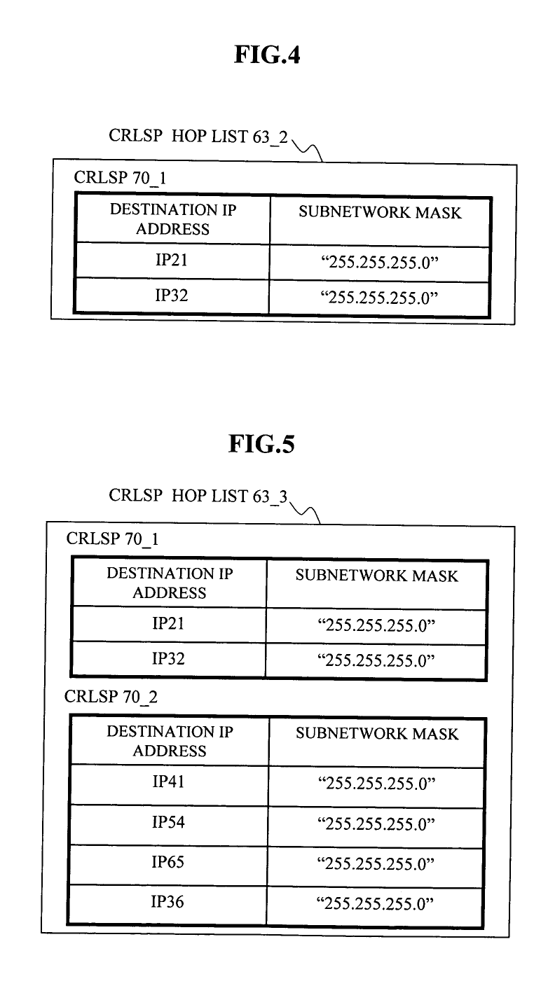

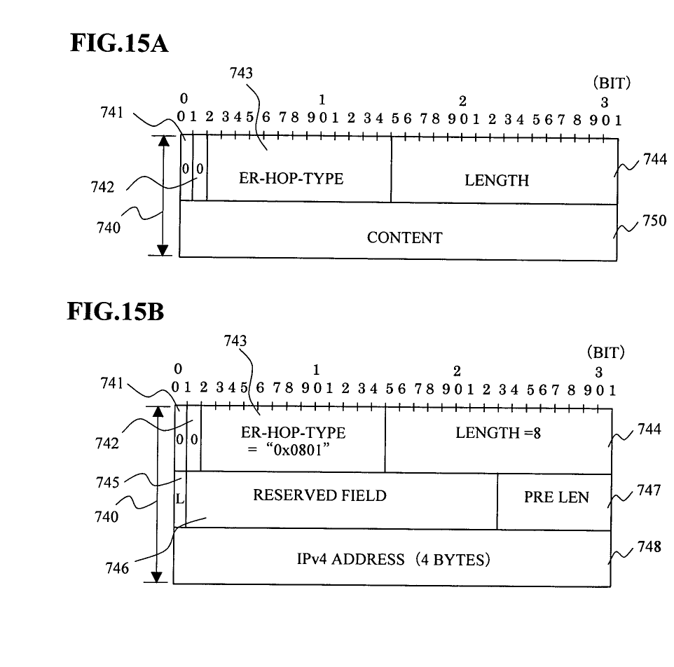

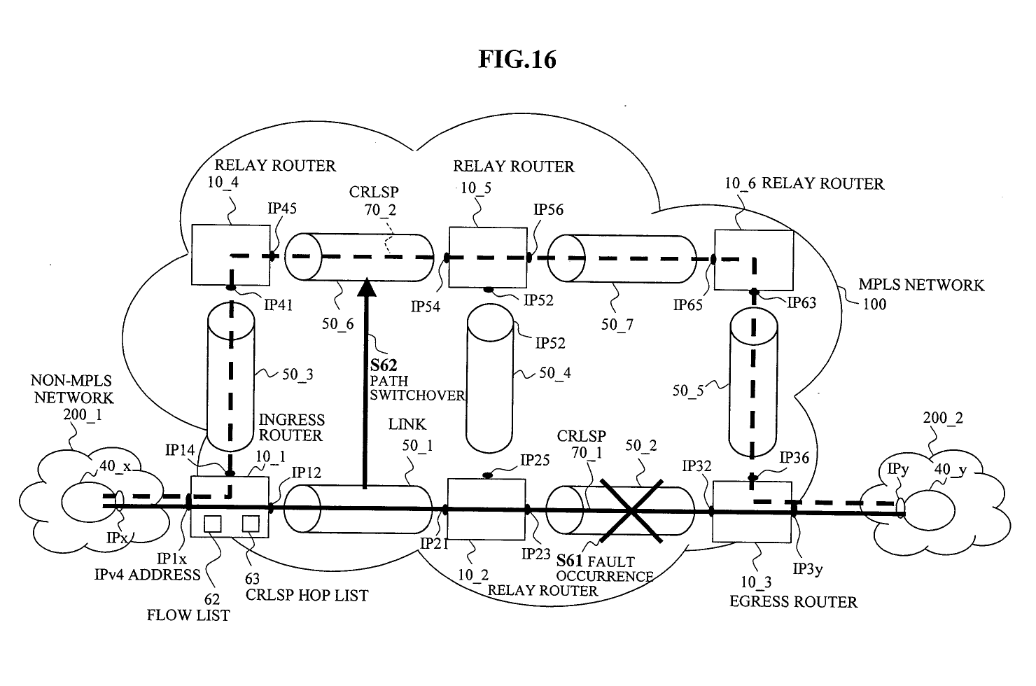

FIG. 4 shows the CRLSP hop list 63_2 of the relay router 10_2. In the destination IP address and the subnetwork mask of the list corresponding to the CRLSP 70_1 in the hop list 63_2, the destination (hop destination) IP addresses=“IP21” and “IP32” included in the explicit route hop TLV 740 (see FIG. 15B) of the label request message 700_1 and the subnetwork mask=“255.255.255.0” obtained from a prefix length 747 of the IP addresses=“24” are set.

Furthermore, the message processor 30_2 forwards the label request message 700_1 from which the explicit route hop TLV 740_1 is not deleted to the IP address=“IP32” indicated in the explicit route hop TLV 740_2 as a label request message 700_2.

Step S13: In the egress router 10_3, the message processor 30_3 (see FIG. 1) recognizes the label request message 700_2 is addressed to its own router 10_3 in the same way as the message processor 30_2 of the relay router 10_2, and stores the hop destinations included in the label request message 700_2 in the CRLSP 70_1 of the CRLSP hop list 63_3. Thus, the egress router 10_3 recognizes the hop destinations of the CRLSP 70_1.

FIG. 5 shows the CRLSP hop list 63_3 held by the egress router 10_3. The list corresponding to the CRLSP 70_1 in this hop list 63_3 is the same as that corresponding to the CRLSP 70_1 in the CRLSP hop list 63_2 shown in FIG. 4.

Steps S14-S16: The message processor 30_3 maps a label L2 to the CRLSP 70_1, and transmits a label mapping message 800_2 including the label L2 to the relay router 10_2. The following operation is the same as the prior art procedure of the CRLSP establishment shown in FIG. 12.

Thus, the label mapped to the CRLSP 70_1 is stored in the ingress router 10_1 and the relay router 10_2.

The ingress router 10_1 establishes the second-priority CRLSP 70_2 in the same way as the establishment of the first-priority CRLSP 70_1.

Namely, in the ingress router 10_1, the message processor 30_1 transmits to the relay router 10_4 the label request message 700 where the hop destination IP addresses=“IP41”, “IP54”, “IP65”, and “IP36” and the prefix lengths=“24”, “24”, “24”, and “24” based on the subnetwork masks of the list (see FIG. 2C) corresponding to the CRLSP 70_2 in the CRLSP hop list 63_1 are respectively set in the explicit route hop TLV's 740_1-740_4 (see FIG. 14 (n=4) and 15B).

The relay routers 10_4-10_6 and the egress router 10_3 sequentially receive the label request message 700, and respectively prepare a list corresponding to the CRLSP 70_2 in CRLSP hop lists 63_4-63_6 and 63_3.

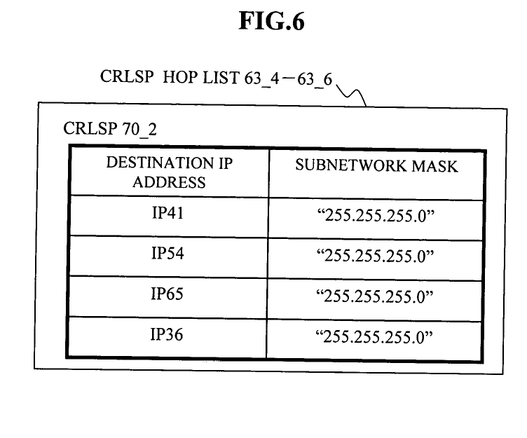

FIG. 6 shows the CRLSP hop lists 63_4-63_6 (hereinafter, occasionally represented by a reference numeral 63) respectively held by the relay routers 10_4-10_6. The list corresponding to the CRLSP 70_2 (only the CRLSP 70_2 is shown in FIG. 6) in the CRLSP hop list 63 is the same as that corresponding to the CRLSP 70_2 in the CRLSP hop list 63_1 shown in FIG. 2C.

The list corresponding to the CRLSP 70_2 in the CRLSP hop list 63_3 of the egress router 10_3 shown in FIG. 5 is the same as that corresponding to the CRLSP 70_2 in the CRLSP hop list 63_1 of FIG. 2C.

Since the egress router 10_3 terminates the CRLSP's 70_1 and 70_2, hop lists corresponding thereto are set in the CRLSP hop list 63_3.

Thus, it becomes possible for the relay routers 10_4-10_6 and the egress router 10_3 to recognize the hop destination of the CRLSP 70_2.

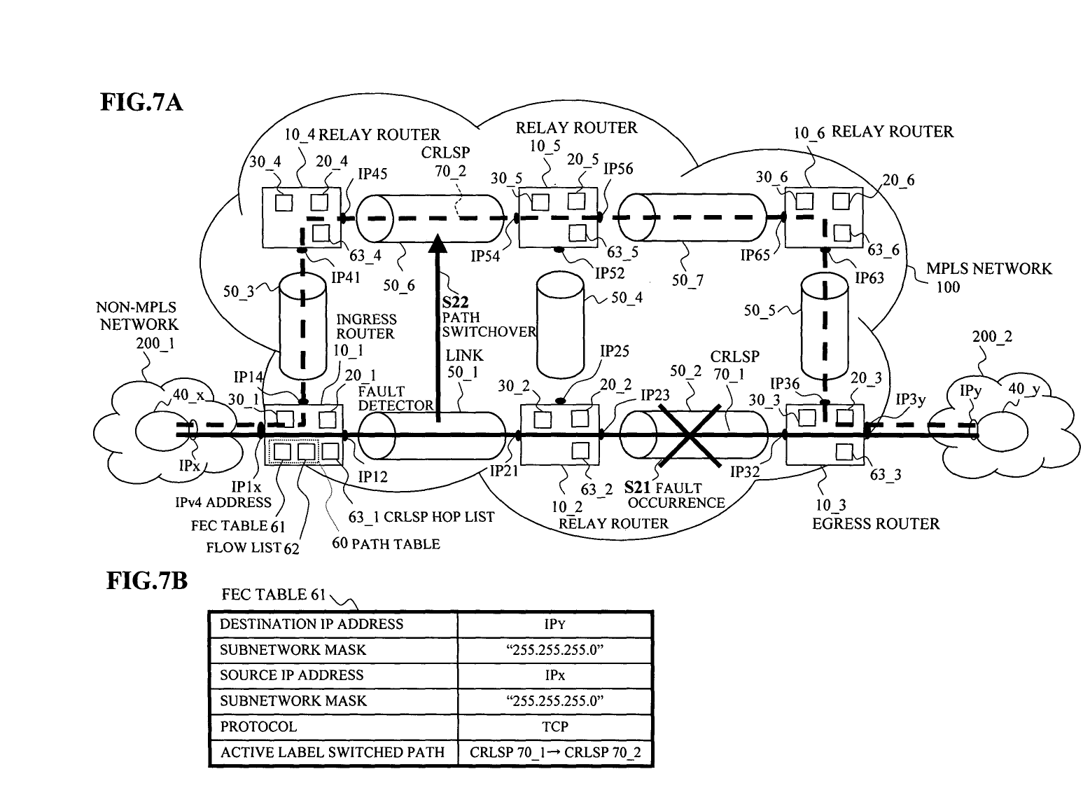

A path switchover when a path fault occurs and a switching back operation when a path recovers from a fault in the MPLS network 100 shown in FIG. 1 will now be described by referring to FIGS. 7-9.

FIGS. 7A and 7B show an operation when a path fault occurs.

Step S21: A fault occurs in the link 50_2 through which the CRLSP 70_1 passes.

Step S22: In the ingress router 10_1, the fault detector 20_1 directly detects the fault of the CRLSP 70_1, or recognizes that a fault has occurred in the CRLSP 70_1 by a path fault notification from the fault detector 20_2 of the relay router 10_2 or the fault detector 20_3 of the egress router 10_3.

The fault detector 20_1 rewrites the active label switched path of the FEC table 61 (see FIG. 7B) from the first-priority CRLSP 70_1 to the second-priority CRLSP 70_2 based on the flow list 62 (see FIG. 2B).

Thus, a path transmitting traffic and corresponding to the FEC table 61 is switched over from the CRLSP 70_1 to the CRLSP 70_2.

It is to be noted that any means by which the relay router 10_2 and the egress router 10_3 can notify the occurrence of the path fault to the ingress router 10_1 can be employed for the present invention. A fault occurrence TLV may be included in a message to be transmitted in which e.g. a value not used in a message type of a label distribution protocol is set.

Also, the ingress router 10_1 may detect a path fault concerning each CRLSP by e.g. OSPF (Open Shortest Path First).

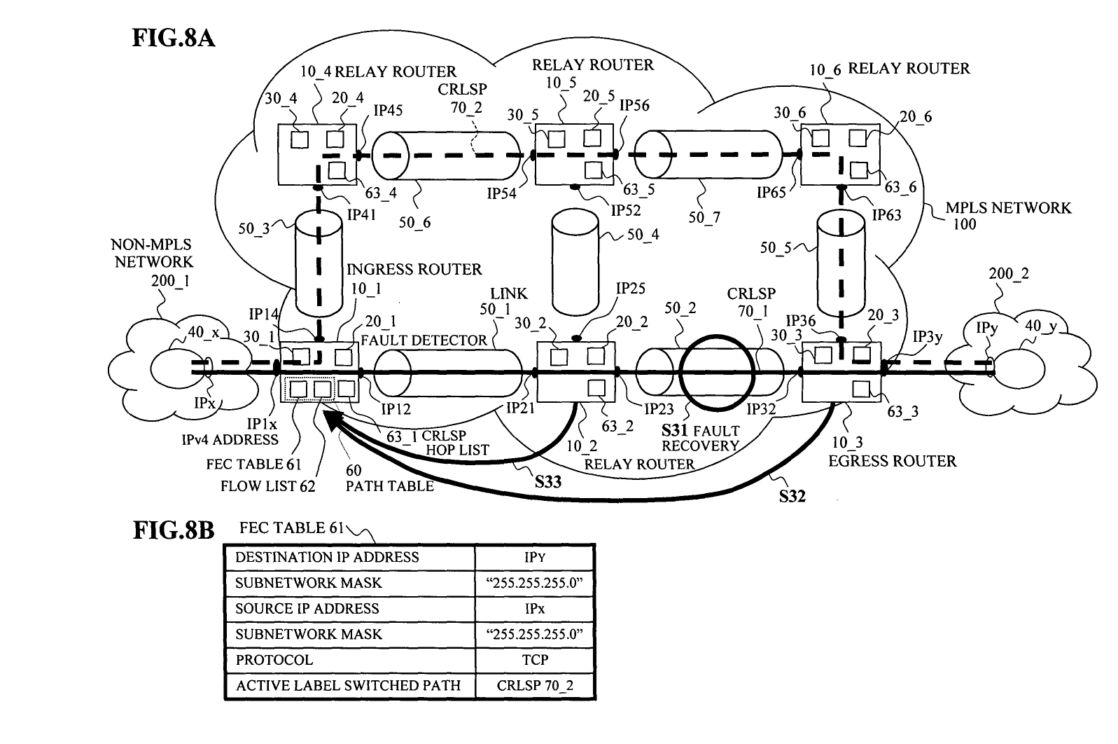

FIGS. 8A and 8B show an operation of detecting a path recovery from a fault.

Step S31: The link 50_2 recovers from the fault. This recovery is detected by the fault detector 20_1 of the ingress router 10_1, the fault detector 20_2 of the relay router 10_2, or the fault detector 20_3 of the egress router 10_3.

When e.g. the link 50_2 is a link from downstream to upstream, its recovery from a fault is detected by a reception of a signal by the relay router 10_2 located at an upstream end. Also, when the link 50_2 is a link from upstream to downstream, the recovery is detected by the fact that the egress router 10_3 located at a downstream end does not receive RDI (Remote Detect Indication) from the facing relay router 10_2.

Steps S32 and S33: The fault detectors 20_2 and 20_3 (hereinafter, occasionally represented by a reference numeral 20) respectively recognize that the IP address concerning the recovered path is the IP address of the hop destination of the CRLSP 70_1 by referring to the CRLSP hop lists 63_2 and 63_3 (hereinafter, occasionally represented by a reference numeral 63).

The fault detector 20 transmits a path fault recovery notification to upstream by referring to the hop list 63. This notification includes the ID of the CRLSP 70_1.

In the upstream router having received this notification, the fault detector 20 transfers the notification to a further upstream router by referring to the hop list 63 based on the ID of the CRLSP 70_1 included in the notification. Thus, the ingress router 10_1 receives the path fault recovery notification.

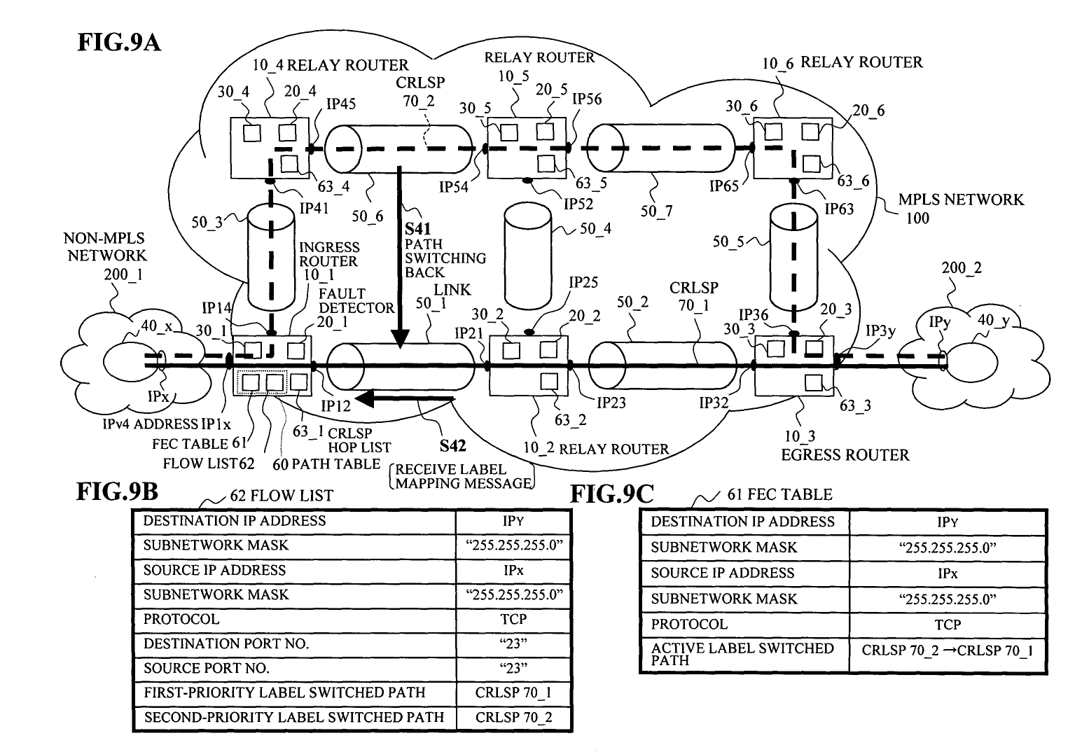

FIGS. 9A-9C show a path switching back operation when a recovery of a fault path higher in priority than the active path is detected.

Step S41: When detecting a path fault recovery concerning the CRLSP 70_1 or receiving a notification of the ID of the CRLSP 70_1, the fault detector 20_1 in the ingress router 10_1 refers to the flow list 62 in FIG. 9B and the FEC table 61 in FIG. 9C and notifies the fault recovery to the message processor 30_1 since the recovered CRLSP 70_1 is higher in priority than the active CRLSP 70_2.

The message processor 30_1 transmits the label request message 700 corresponding to the CRLSP 70_1, receives the label mapping message (see step S42 in FIG. 9A), and acquires a label corresponding to the CRLSP 70_1.

Furthermore, the fault detector 20_1 rewrites the active label switched path=“CRLSP 70_2” in the FEC table 61 to the recovered “CRLSP 70_1” (see FIG. 9C). Thus, the CRLSP 70_{—2} is switched back to the CRLSP 70_1.

It is to be noted that while the above description indicates the case where the label corresponding to the CRLSP 70_1 is released when a fault occurs in the CRLSP 70_1 (see step S21 in FIG. 7), the label need not be released but kept so that it can be used immediately when the fault is recovered. In this case, the message processor 30_1 does not transmit/receive the label request message 700 and the label mapping message.

As a trigger of rewriting an active label switched path in the FEC table 61, namely, a trigger of switching back to the CRLSP 70_1 higher in priority, following (1)-(3) can be mentioned, thereby enabling different services to be provided.

(1) As mentioned above, after a reception of a path fault recovery notification, the active path is switched back.

(2) A test packet is transmitted after a reception of a recovery notification, and when an acknowledge signal is returned from the egress router 10_3, the active path is switched back.

(3) When a fault occurs in the active CRLSP 70_2 lower in priority and is disconnected after a reception of a recovery notification, the active path is switched back to the CRLSP 70_1 higher in priority.

It is to be noted that in the above-mentioned embodiment, the relay router 10_2 and the egress router 10_3 store all of the hop destinations of the CRLSP 70_1 in the CRLSP hop list 63. However, each router stores the IP addresses of all the hop destinations of the upstream routers, or even a single IP address of the hop destination of the next upstream router associated with the CRLSP 70_1, thereby enabling the transmission of the path fault recovery notification to the ingress router 10_1.

Also, each router holds the IP address of its own router connected to the CRLSP 70_1 and the IP address of the ingress router 10_1 associated with the CRLSP 70_1, thereby enabling the transmission of the path fault recovery notification to the ingress router 10_1.

In this case, e.g. the ingress router 10_1 can have its own IP address included in the label request message to be transmitted.

The ingress router 10_1 can detect the recovery of the path fault e.g. by the OSPF. However, when detecting the recovery by the OSPF, the ingress router 10_1 has to always monitor whether or not a path fault concerning the CRLSP has recovered.

On the other hand, by the label switching router according to the present invention, the ingress router 10_1 can easily switch back to a CRLSP higher in priority, since the path fault recovery notification corresponding to the CRLSP is provided from the relay router or the egress router.

As described above, a label switching router and a switchover control method thereof according to the present invention are arranged so that a message processor in a relay label switching router registers a hop destination indicated in a received message in a path hop list, forwards the message to a next hop destination without deleting the hop destination, and notifies an identifier of a path in which a fault has recovered to an ingress label switching router based on the path hop list, a message processor in an egress label switching router registers the hop destination indicated in the received message in a path hop list, and notifies an identifier of a path in which a fault has recovered to the ingress label switching router based on the path hop list, and a fault detector in the ingress label switching router regards, when detecting a recovery of a path higher in priority than an active path or when receiving a recovery notification, the recovered path as an active path. Therefore, it becomes possible to switch back to a path higher in priority as an active path, when the path higher in priority is recovered from a fault.

Namely, it becomes possible to switch back to a route higher in priority only by a recovering operation from a fault, without stopping communication services, even if a fault occurs in a transmission line. Also, constant best effort communications due to a plurality of fault occurrences can be avoided. Furthermore, by applying the label switching router and the switchover control method thereof, merits of services, which adopts the detour function of the redundant CRLSP route with the MPLS, can be effectively used.

What we claim is:

1. An ingress label switching router comprising:
a path table for designating an active path from among a plurality of paths through which packets of an equivalence class are forwarded and for which priorities are set; and
a fault detector for operating the active path by referring to the path table and for setting, when detecting a recovery of a path higher in priority than the active path, the recovered path in the path table as an active path.

2. The ingress label switching router as claimed in claim 1 wherein when detecting a path recovery from a fault, the fault detector immediately sets the recovered path in the path table as an active path.

3. The ingress label switching router as claimed in claim 1 wherein when detecting a path recovery from a fault, the fault detector confirms the path recovery by testing the recovered path, and then sets the recovered path in the path table as an active path.

4. The ingress label switching router as claimed in claim 1 wherein when a fault occurs in the active path after a path recovery from a fault is detected, the fault detector sets the recovered path in the path table as an active path.

5. A relay label switching router comprising:
a path hop list for indicating a hop destination of a path through which a packet of an equivalence class is forwarded;
a message processor for registering the hop destination indicated in a received message in the path hop list and for forwarding the message to a next hop destination without deleting the hop destination; and
a fault detector for notifying an identifier of a path in which a fault has recovered to an ingress label switching router based on the path hop list.

6. The relay label switching router as claimed in claim 5 wherein the fault detector notifies an identifier, detected by the fault detector itself or notified by a downstream label switching router, of a path in which a fault has recovered to an upstream label switching router based on the path hop list.

7. The relay label switching router as claimed in claim 5 wherein the message includes an address of an ingress label switching router as a hop destination, the message processor registers the address associated with the path in the path hop list, and the fault detector directly notifies a path recovery from a fault to the ingress label switching router.

8. The relay label switching router as claimed in claim 5 wherein the message comprises a label request message.

9. An egress label switching router comprising:
a path hop list for indicating a hop destination of a path through which a packet of an equivalence class is forwarded;
a message processor for registering the hop destination indicated in a received message in the path hop list; and
a fault detector for notifying an identifier of a path in which a fault has recovered to an ingress label switching router based on the path hop list.

10. The egress label switching router as claimed in claim 9 wherein the fault detector notifies an identifier, detected by the fault detector itself, of a path in which a fault has recovered to an upstream label switching router based on the path hop list.

11. The egress label switching router as claimed in claim 9 wherein the message includes an address of an ingress label switching router as a hop destination, the message processor registers the address associated with the path in the path hop list, and the fault detector directly notifies a path recovery from a fault to the ingress label switching router.

12. The egress label switching router as claimed in claim 9 wherein the message comprises a label request message.

13. A path switchover control method of an ingress label switching router comprising:
a first step of designating an active path from among a plurality of paths through which packets of an equivalence class are forwarded and for which priorities are set; and
a second step of operating the active path by referring to the path table and for setting, when detecting a recovery of a path higher in priority than the active path, the recovered path in the path table as an active path.

14. The path switchover control method of the ingress label switching router as claimed in claim 13 wherein when a path recovery from a fault is detected, the second step immediately sets the recovered path in the path table as an active path.

15. The path switchover control method of the ingress label switching router as claimed in claim 13 wherein when a path recovery from a fault is detected, the second step confirms the path recovery by testing the recovered path, and then sets the recovered path in the path table as an active path.

16. The path switchover control method of the ingress label switching router as claimed in claim 13 wherein when a fault occurs in the active path after a path recovery from a fault is detected, the second step sets the recovered path in the path table as an active path.

17. A path switchover control method of a relay label switching router comprising:
a first step of registering in a path hop list a hop destination indicated in a received message of a path, through which a packet of an equivalence class is forwarded;
a second step of forwarding the message to a next hop destination without deleting the hop destination; and
a third step of notifying an identifier of a path in which a fault has recovered to an ingress label switching router based on the path hop list.

18. The path switchover control method of the relay label switching router as claimed in claim 17 wherein the third step notifies an identifier, detected by its own relay label switching router or notified by a downstream label switching router, of a path in which a fault has recovered to an upstream label switching router based on the path hop list.

19. The path switchover control method of the relay label switching router as claimed in claim 17 wherein the message includes an address of an ingress label switching router as the hop destination,
the first step registers the address associated with the path in the path hop list, and
the third step directly notifies an identifier of a path in which a fault has recovered to the ingress label switching router.

20. The path switchover control method of the relay label switching router as claimed in claim 17 wherein the message comprises a label request message.

21. A path switchover control method of an egress label switching router comprising:
a first step of registering in a path hop list a hop destination indicated in a received message of a path, through which a packet of an equivalence class is forwarded; and
a second step of notifying an identifier of a path in which a fault has recovered to an ingress label switching router based on the path hop list.

22. The path switchover control method of the egress label switching router as claimed in claim 21 wherein the second step notifies an identifier, detected by its own egress label switching router, of a path in which a fault has recovered to an upstream label switching router based on the path hop list.

23. The path switchover control method of the egress label switching router as claimed in claim 21 wherein the message includes an address of an ingress label switching router as a hop destination, the first step registers the address associated with the path in the path hop list, and the second step directly notifies a path recovery from a fault to the ingress label switching router.

24. The path switchover control method of the egress label switching router as claimed in claim 21 wherein the message comprises a label request message.
